(19) United States
(12) Patent Application Publication
(10) Pub. No.: US 2014/0297576 A1
(43) Pub. Date: Oct. 2, 2014

(54) SYSTEM AND METHOD FOR DETECTING DUPLICATION IN DATA FEEDS

(71) Applicant: Google Inc., (US)

(72) Inventors: Ashutosh KULSHRESHTHA, San Jose, CA (US); Joshua Lamar MOORE, Ithaca, NY (US)

(73) Assignee: Google Inc., Mountain View, CA (US)

(21) Appl. No.: 13/854,874

(22) Filed: Apr. 1, 2013

(51) Int. Cl. G06N 5/04

(52) U.S. Cl. CPC G06N 5/04
USPC 706/46; 707/692

(57) ABSTRACT

A system and method for filtering data sources is provided. Data corresponding to an entity listing is received from a set of data sources including one or more primary data sources and at least one secondary data source. The received data is grouped based attributes of the entity listing. Common values between data from the one or more primary data sources and data from the at least one secondary data source are identified for each attribute of the entity listing. A probability that one of the at least one secondary data source copied data from the one or more primary data sources is calculated based on the identified common values. A determination of whether the calculated probability is greater than a predetermined value is made. If the calculated probability is greater than the predetermined value, the one data source is removed from the at least one secondary data source.

### FIELD

The present disclosure generally relates to data feeds, and, in particular, to determining duplications in data feeds for mapping applications.

### BACKGROUND

Web-based applications commonly provide information drawn from several different sources. For example, a web-based mapping application may provide information such as business names, addresses, locations, telephone numbers, and URLs for listings. Such information may be derived from a variety of different sources. Thus, it may be desirable to implement a system that determines duplications in data feeds for mapping applications.

### SUMMARY

The disclosed subject matter relates to a machine-implemented method for filtering data sources. Data corresponding to an entity listing is received from a set of data sources including one or more primary data sources and at least one secondary data source. The received data is grouped based on at least one attribute of the entity listing. Common values between data from the one or more primary data sources and data from the at least one secondary data source are identified for each of the at least one attribute of the entity listing. A probability that one of the at least one secondary data source copied data from the one or more primary data sources is calculated based on the identified common values. A determination of whether the calculated probability is greater than a predetermined value is made. If the calculated probability is greater than the predetermined value, the one data source is removed from the at least one secondary data source.

According to various aspects of the subject technology, a system for determining filtering data sources in a web-based mapping application is provided. The system includes one or more processors and a machine-readable medium including instructions stored therein, which when executed by the processors, cause the processors to receive data corresponding to an entity listing of the mapping application from a set of data sources including one or more primary data sources and a secondary data source. The received data is grouped based on at least one attribute of the entity listing. For each attribute of the entity listing, common values between data are identified from the one or more primary data sources and data from the secondary data source. A probability that the secondary data source copied data from the one or more primary data sources is calculated based on the identified common values. A determination of whether the calculated probability is greater than a predetermined value is made. If the calculated probability is greater than the predetermined value, the secondary data source is provided to a user for inspection. An indication of input commands from the user is received. The indication of the input commands from the user causes the secondary data source to be maintained in or deleted from a list of data sources.

The disclosed subject matter also relates to a machine-readable medium comprising instructions stored therein, which when executed by a system, cause the system to perform operations comprising receiving a first set of data for a listing from a primary data source and receiving a second set of data for the listing from a secondary data source. The secondary data source is one of a plurality of secondary data sources, and each of the first and second set of data includes at least one attribute. Common attributes from the first and second sets of data for the listing are identified. A probability that the set of data from the secondary data source was copied from the set of data from the primary data source is calculated based on the identified common attributes. The secondary data source is removed from the plurality of secondary data sources when the calculated probability that the set of data from the secondary data source was copied from the set of data from the primary data source is greater than a predetermined value.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment which provides for determining duplications in data feeds.

FIG. 2 illustrates an example of a server system for determining duplications in data feeds.

FIG. 3 provides a graphical representation of relationships between actual data and two data sources.

FIG. 4 illustrates an example method for determining whether duplication exists between two data feeds.

FIG. 5 illustrates an example method for determining duplications in several data feeds.

FIG. 6 is a spreadsheet illustrating example data for values of entity listing attributes from a number of sources.

FIG. 7 conceptually illustrates an example electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The disclosed subject matter provides for a machine-implemented method for filtering data sources. Data corresponding to an entity listing is received from a set of data sources including one or more primary data sources and a secondary data source. The received data is grouped based on at least one attribute of the entity listing. For each attribute of the entity listing, common values between data from the one or more primary data sources and data from the secondary data source are identified. A probability that the secondary data source copied data from the one or more primary data sources is calculated based on the identified common values. The secondary data source is removed from a list of data sources when the calculated probability of copying from the one or more primary data sources is greater than a predetermined value.

When a web-based application retrieves information such as business names, addresses, location, telephone numbers, and URLs for listings, such information may be retrieved from a variety of sources such as commercial feeds or from different web pages. Commercial feeds generally provide data from a collection of facts while web pages may provide data from a similar collection of facts, from commercial feeds, or from other web pages. Given the number of sources from which data may be drawn, it may be desirable to implement a system that calculates the probability that certain secondary data sources copied data from one or more primary data sources. Secondary data sources identified as copying from one or more primary data sources may be eliminated as sources from which web-based applications obtain information.

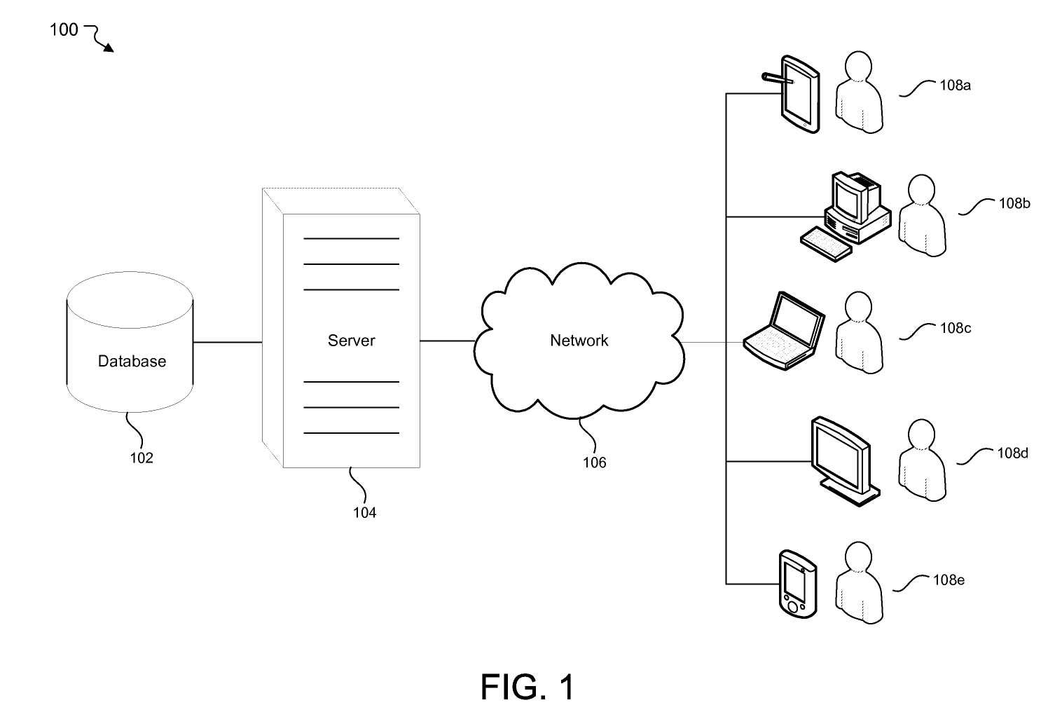

FIG. 1 illustrates an example network environment which provides for determining duplications in data feeds. Network environment 100 comprises one or more databases 102 (e.g., computer-readable storage devices) for storing a variety of information that is utilized by web-based applications. The network environment 100 further comprises one or more servers 104. Server 104 may receive requests from user-operated client devices 108a-108e. Server 104 and client devices 108a-108e may be communicatively coupled through a network 106. In some implementations, client devices 108a-108e may request data from server 104. Upon receiving the request, server 104 may retrieve a set of data from database 102 and serve the set of information to client devices 108a-108e.

Each of client devices 108a-108e can represent various forms of processing devices. Example processing devices can include a desktop computer, a laptop computer, a handheld computer, a television with one or more processors attached or coupled thereto, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices. Each of client devices 108a-108e may be any machine configured to generate and transmit a signal that includes location information (e.g., GPS coordinates) to server 104. In some aspects, client devices 108a-108e may include one or more client applications (e.g., mapping applications, GPS applications, or other processes) configured to generate and transmit GPS signals to a server. The GPS signals may include GPS coordinates (e.g., longitude and latitude coordinates) and, in some cases, a time stamp indicating when the GPS signal was generated.

In some aspects, client devices 108a-108e may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. For example, the communication may occur through a radio-frequency transceiver (not shown). In addition, short-range communication may occur, such as using a Bluetooth, WiFi, or other such transceiver.

In some aspects, network environment 100 can be a distributed client/server system that spans one or more networks such as network 106. Network 106 can be a large computer network, such as a local area network (LAN), wide area network (WAN), the Internet, a cellular network, or a combination thereof connecting any number of mobile clients, fixed clients, and servers. In some aspects, each client (e.g., client devices 108a-108e) can communicate with servers 104 via a virtual private network (VPN), Secure Shell (SSH) tunnel, or other secure network connection. In some aspects, network 106 may further include a corporate network (e.g., intranet) and one or more wireless access points.

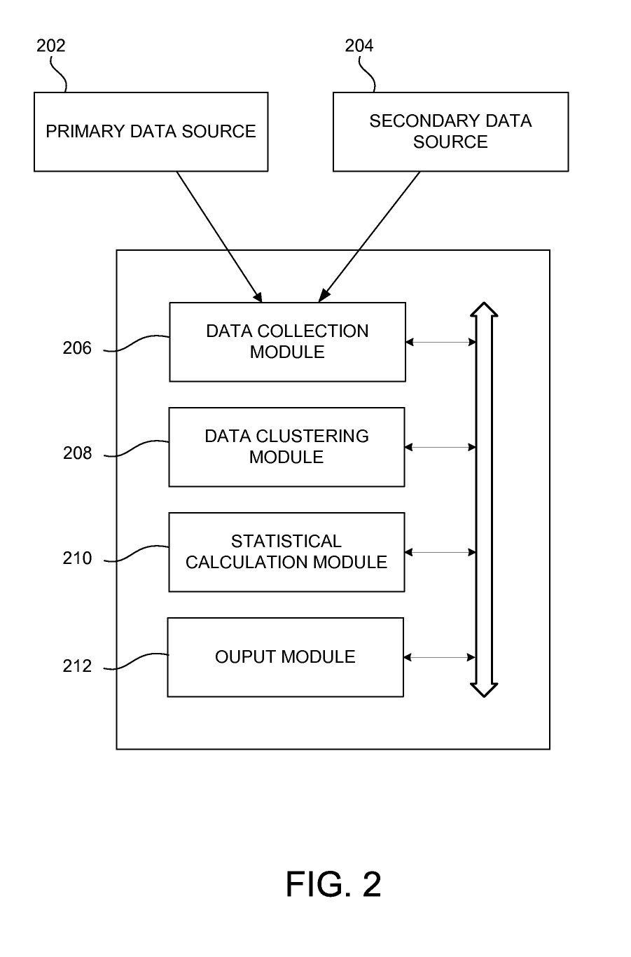

FIG. 2 illustrates an example of a system for determining duplications in data feeds. System 200 includes data collection module 206, data clustering module 208, statistical calculation model 210, and output module 212. These modules, which are in communication with one another, process information received from primary data source 202 and secondary data source 204, in order to determine whether or not secondary data source 204 is a duplication of primary data source 202. For example, information relating to a same listing on a mapping application may be received by data collection module 206 from primary data source 202 and secondary data source 204. The data may be grouped by attributes by data clustering module 208. The grouped data may then be statistically analyzed by statistical calculation module 210 to determine a probability that second data source 204 copied data from primary data source 206. Results of the statistical calculation are returned by the output module 212.

In some aspects, the modules may be implemented in software (e.g., subroutines and code). The software implementation of the modules may operate on web browsers running on client devices 108a-108e. In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

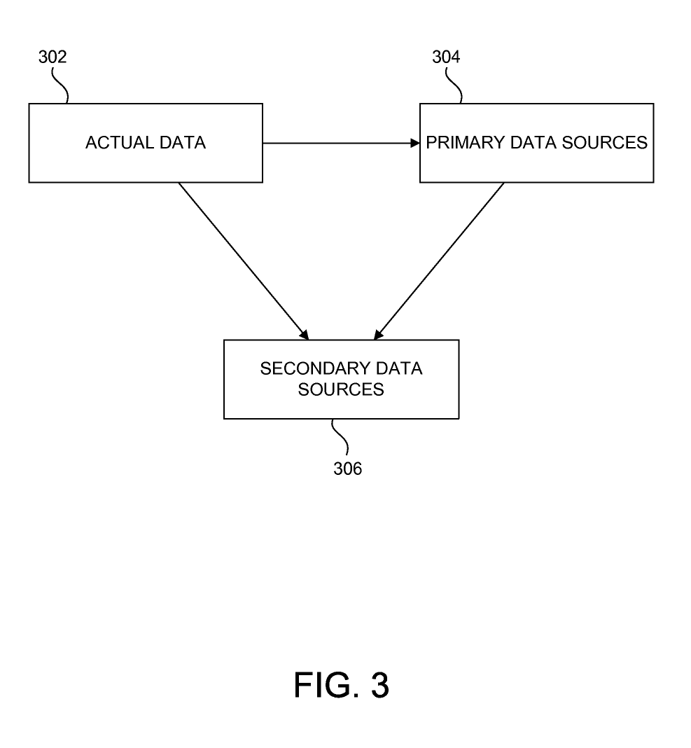

FIG. 3 provides a graphical representation of relationships between actual data and two data sources. Actual data 302 represents real world information of individual entities. Primary data sources 304 draws information in the form of values for certain attributes (e.g., business names, addresses, locations, telephone numbers, email addresses, and URLs) from actual data 302, and thus may have a small probability of error. Secondary data sources 306, on the other hand, obtain information by drawing from actual data 302 or by copying from other data sources such as primary data sources 304 or other secondary data sources 306. The distribution at which each of secondary data sources 306 copies from actual data 302 and other data sources may not be known.

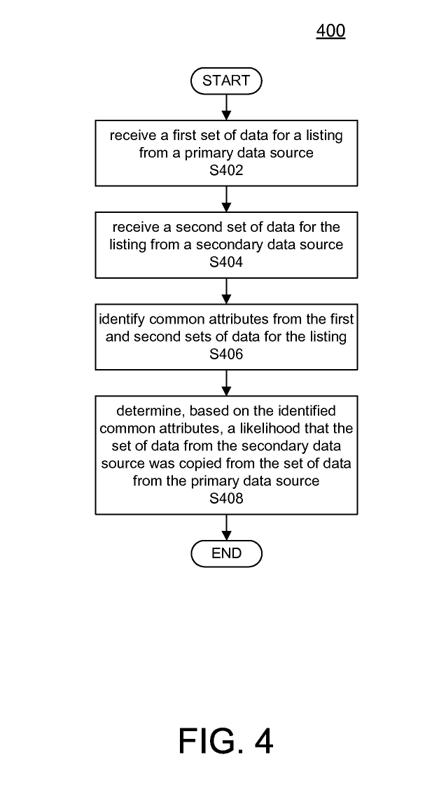

FIG. 4 illustrates an example method for determining whether duplication exists between two data feeds. A first set of data for a listing is received from a primary data source in S402 and a second set of data for the listing is received from a secondary data source in S404. The sets of data for the listing may each include a combination of attributes including business names, addresses, locations (i.e., latitude and longitude coordinates). telephone numbers, email addresses, and URLs. Common attributes from the first and second sets of data for the listing are identified in S406. A likelihood that the set of data from the secondary data source was copied from the set of data from the primary data source is determined based on the identified common attributes, in S408. For example, the likelihood that the set of data from the secondary data source was copied from the set of data from the primary data source can be calculated via a Bayesian method, as described in further details below.

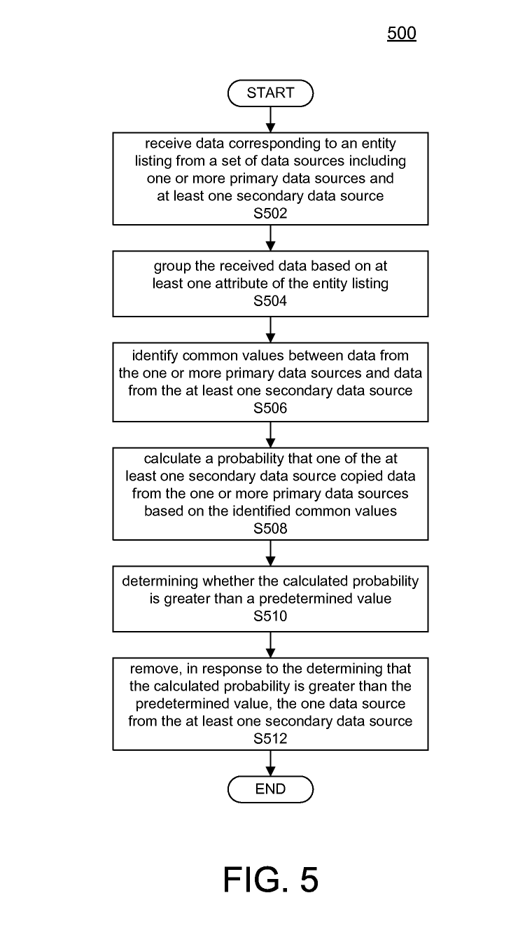

FIG. 5 illustrates example method 500 for determining duplications in several data feeds. Data corresponding to an entity listing (e.g., a business listing) from a set of data sources including one or more primary data sources and a secondary data source is received in S502. Primary data sources may include commercial feeds that provide information such as business names, addresses, locations, telephone numbers, email addresses, and URLs for the entity listings. Secondary data sources, on the other hand, may include web pages that provide similar information for the entity listings. The received data corresponding to the entity listings is grouped based on at least one attribute of the entity listing in S504. The attributes from which the received data may be grouped may include business name, address, location, telephone number, email address, or URL. For example, data received from the one or more primary data sources and the secondary data source relating to an attribute such as a telephone number may be grouped together.

In S506, the grouped data is analyzed to identify common values between data from the one or more primary data sources and data from the secondary data source. Information such as a same address, a same telephone number, a same email address, or a same URL received from the one or more primary data source and the secondary data source may be identified as common values between the one or more primary data source and the secondary data source. A probability that the secondary data source copied data from the one or more primary data sources is calculated based on the identified common values in S508.

In S510, a determination of whether the calculated probability is greater than a predetermined value is made. The predetermined value provides a threshold value which, when exceeded, causes the secondary data source to be identified as copying from the one or more primary data sources. The secondary data source may be removed from a list of secondary data sources in response to the determination that the calculated probability is greater than the predetermined value, in S512. For example, if a web page is determined to have a high probability of copying attributes of a listing from a commercial feed, the web page may be eliminated as a source of attribute information since the web page provides redundant information that is no more accurate than the information that has already been provided by the commercial feed. Web pages determined to have low probabilities of copying are maintained for consideration as sources of data.

In some implementations, a Bayesian method may be utilized to calculate the probability that the secondary data source copied data from the one or more primary data sources. Derivation of the probability of a first source copying a second source may be based on the following model.

Assume that source i has values for set of entity listing attributes (the set Ai) and source j also has values for the same set of entity listing attributes (the set Aj). For a particular entity listing attribute k (e.g., a phone number, a website, an address, a name for a listing, etc.), the primary source i has value Aik and secondary source j has value Ajk. For one or more entity listing attributes, source i may have the same value as source j. Source i may also have a different value for a particular entity listing attribute than source j. Assume that a variable Cij indicates that source j copied attribute values from source i.

We are interested in detecting the probability that source j copied attribute values from source i given the attribute values obtained from source i and source j. This can be written as P(Cij|Ail, . . . , Aik, . . . , AiN, Ajl, . . . , Ajk, . . . , AjN), where values for attributes Al through AN given by the two sources are common to both sources. Using the Bayesian method, we can derive Equation (1) below.

$$P ( Cij \vert Ai 1 , … , Aik , … , AiN , Aj 1 , … Ajk , … AjN ) = \frac{P ( \begin{matrix}Ai 1 , … , Aik , … , AiN , \\ Aj 1 , … Ajk , … AjN \vert Cij\end{matrix} ) * P ( Cij )}{\begin{matrix}P ( Ai 1 , … , Aik , AiN , Aj 1 , … Ajk , … AjN \vert Cij ) * \\ P ( Cij ) + P ( \begin{matrix}A i 1 , … , Aik , … , AiN , \\ Aj 1 , … Ajk , … AjN \vert not Cij\end{matrix} ) * \\ P ( not Cij )\end{matrix}} \qquad Equation ( 1 )$$

Here, P(Cij|Ail, . . . , Aik, . . . , AiN, Ajl, . . . Ajk, . . . AjN) is the probability that source j copied attribute values from source i given the attribute values obtained from source i and source j. P(Ail, . . . , Aik, . . . , AiN, Ajl, . . . Ajk, . . . AjN|Cij) is equal to the probability of source j and source i getting the attribute values they respectively have given the fact that source j copied from source i. P(Cij) is the probability that source j copied from source i. P(Ail, . . . , Aik, . . . , AiN, Ajl, . . . , Ajk, . . . , AjN|not Cij) is the probability of source j and source i getting the attribute values they respectively have given the fact that source j did not copy from source i. And P(not Cij) is the probability that source j did not copy from source i.

For particular attributes, the probability that the value of a particular attribute k from source i is the same as the value for the attribute from source j if source j copied from source i may be written as P(Aik=Ajk|Cij). The probability that the value of a particular attribute k from source i is not the same as the value for the attribute from source j if source j copied from source i may be written as P(Aik !=Ajk|Cij). Such situations may occur if, for example, there is an error in the duplication process. The probability that the value of a particular attribute k from source i is the same as the value for the attribute from source j if source j did not copy from source i may be written as P(Aik=Ajk|not Cij). Such situations may occur when both sources obtain a value for the attribute independently. The probability that the value of a particular attribute k from source i is not the same as the value for the attribute from source j if source j did not copy from source i may be written as P(Aik !=Ajk|not Cij). Such situations may occur during an error in the data collection process.

In some implementations, a degree of difference between values for attributes may be determined and taken into consideration. Thus, attributes values between data sources that are different may nonetheless be considered the same if the degree of difference between the attribute values is less than a threshold. Alternatively, the probability that a source i copied a value of a particular attribute from a source j may be based, in part, on the degree of difference between the values of the attribute recorded by sources i and j, respectively. The degree of difference may be calculated based on, for example, the number of different characters in the string of characters, how far apart different characters are, or using any other method of calculating degrees of difference between values. In other implementations, however, values for attributes recorded by sources i and j are considered the same only when the values are identical.

When only considering the equality of values for attributes (i.e., that attribute values are the same only when they are identical), Equation (1) above may be simplified by using a new variable Xijk which represents whether the value for entity listing attribute k is the same for source i and source j. If, for example, the value Aik (the value of attribute k from source i) is equal to the value Ajk (the value of attribute k from source j), then Xijk=1. If, on the other hand, Aik !=Ajk, then Xijk=0. Equation (1) may be rewritten in terms of variable Xijk instead of in terms of Aik and Ajk. For example, Equation (1) may be rewritten as Equation (2) below.

$$P ( Cij \vert Ai 1 , … , Aik , … , AiN , Aj 1 , … Ajk , … AjN ) = P ( Cij \vert Xij 1 , … , XijN ) = \frac{P ( Xij 1 , … , XijN \vert Cij ) * P ( Cij )}{\begin{matrix}P ( Xij 1 , … , XijN \vert Cij ) * P ( Cij ) + \\ P ( Xij 1 , … , XijN \vert not Cij ) * P ( not Cij )\end{matrix}} \qquad Equation ( 2 )$$

If the attribute values are independent of one another (e.g., they are independent events) or if they may be assumed to be independent, then Equation (2) can be simplified by Equations (3) below.

$$P ( Xij 1 , … , XijN \vert Cij ) = {{\prod }_{k = 1}}^{N} P ( Xijk \vert Cij ) \\ And \\ P ( Xij 1 , … , XijN \vert not Cij ) = {\prod }_{k = 1}^{N} P ( Xijk \vert not Cij ) \qquad Equation ( 3 )$$

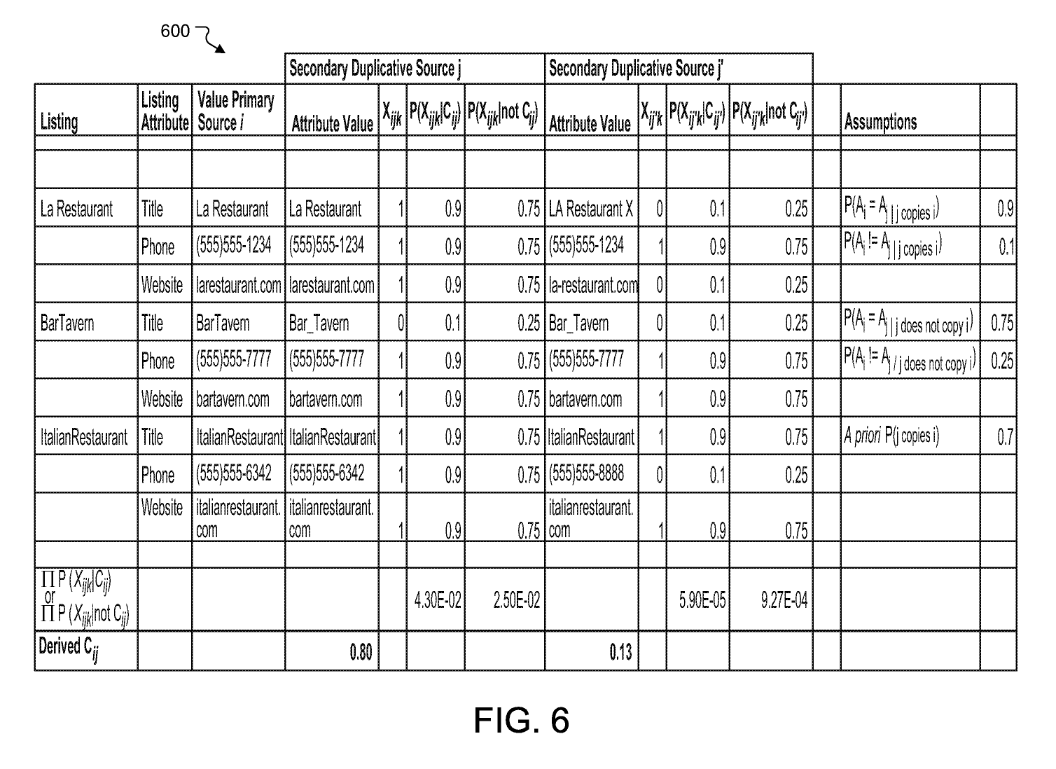

FIG. 6 illustrates the use of these formulas in calculating the probability that source j copied attribute values from source i given the attribute values obtained from source i and source j. FIG. 6 is a spreadsheet 600 illustrating example data for values of entity listing attributes from a number of sources. The spreadsheet 600 includes data corresponding to 3 entity listings (e.g., business listings) received from a primary source i and two secondary sources j and j′. The data received from the sources may be grouped based on entity listing attributes such as a title, a phone number, and a website as shown in spreadsheet 600.

Common values for entity listing attributes may be identified between the data from the primary source and the secondary sources and used to calculate a probability that one of the secondary sources copied data from the primary source. For example, using the Bayesian method, as described above, a probability that secondary source j copied data from primary source i and a probability that secondary source j′ copied data from primary source i may be calculated.

According to some aspects, certain probabilities used to calculate the probability that a secondary source copied a primary source may be set by, for example, an administrator or the statistical calculation module 210. They may be set or modified based on prior calculations or selected as calculation parameters. For example, in spreadsheet 600, the following values for probabilities may be set or assumed:

The probability that the value of a particular attribute k from source i is the same as the value for the attribute from source j if source j copied from source i:

P(Aik=Ajk|Cij)=0.9

The probability that the value of a particular attribute k from source i is not the same as the value for the attribute from source j if source j copied from source i:

P(Aik=Ajk|Cij)=0.1

The probability that the value of a particular attribute k from source i is the same as the value for the attribute from source j if source j did not copy from source i:

P(Aik=Ajk|not Cij)=0.75

The probability that the value of a particular attribute k from source i is not the same as the value for the attribute from source j if source j did not copy from source i:

P(Aik=Ajk|not Cij)=0.25

The probability that a secondary source copies from a primary source:

P(j copies i): 0.7

The probability that a secondary source does not copy from a primary source:

P(j does not copy i): 0.3

Column Xijk in spreadsheet 600 shows the result of comparing the attribute value in the secondary source j to the attribute value in the primary source i. For example, if the attribute values match, the value in the Xijk column is 1. If the values do not match, the value in the Xijk column is 0. Similarly, column Xijk in spreadsheet 600 shows the result of comparing the attribute value in the secondary source j′ to the attribute value in the primary source i.

Column P(Xijk|Cij) shows the probability of Xijk given that source j copied source i. The values in this column are taken from the probabilities that were set above. In other words P(Xijk|Cij)=P(Aik=Ajk|Cij)=0.9 if the attributes values for source j and source i match (e.g., Xijk=1) and P(Xijk|Cij)=P(Aik !=Ajk|Cij)=0.1 if the attributes values for source j and source i do not match (e.g., Xijk=0). Similarly, column P(Xij′k Cij′) shows the probability of Xij′k given that source j′ copied source i.

Column P(Xijk|not Cij) shows the probability of Xijk given that source j did not copy source i. The values in this column are also taken from the probabilities that were set above. In other words P(Xijk|not Cij)=P(Aik=Ajk|not Cij)=0.75 if the attributes values for source j and source i match (e.g., Xijk=1) and P(Xijk|not Cij)=P(Aik !=Ajk|not Cij)=0.25 if the attributes values for source j and source i do not match (e.g., Xijk=0). Similarly, column P(Xij′k|not Cij′) shows the probability of Xij′k given that source j′ did not copy source i.

Further below, in column P(Xijk|Cij) is the calculated product of all the previous values in the row

$$( e . g . , {\prod }_{k = 1}^{N} P ( Xijk \vert Cij ) ) .$$

Further below, in column P(Xijk|not Cij) is also the calculated product of all the previous values in the row

$$( e . g . , {\prod }_{k = 1}^{N} P ( Xijk \vert not Cij ) ) .$$

These values may then be inserted into a Bayesian method equation

$$( e . g . , \frac{P ( Xij 1 , … , XijN \vert Cij ) * P ( Cij )}{\begin{matrix}P ( Xij 1 , … , XijN \vert Cij ) * P ( Cij ) + \\ P ( Xij 1 , … , XijN \vert not Cij ) * P ( not Cij )\end{matrix}} )$$

and used to derive the probability that source j copied source i. The result of the calculation is displayed in spreadsheet 600 in the “Derived Cij” row. Similarly, the values in spreadsheet 600 may be used to derive the probability that source j′ copied source i.

The calculated probabilities may then be compared with a threshold probability (e.g., 0.5, or 0.8) to determine whether one of the secondary data sources should be removed from the set of sources. For example, based on the data in spreadsheet 600, the calculated probability that secondary source j copied from primary source i is roughly 0.80. If the threshold probability is 0.5, since the probability that source j copied from source i exceeds the threshold, source j may be considered to have copied from primary source i. Accordingly, source j may be removed from the set of sources. The calculated probability that secondary source j′ copied from primary source i is roughly 0.13. Since the probability for source j′ does not exceed the threshold, it is not considered to have copied source i and can remain in the set of sources.

Additional factors may be utilized by the Bayesian model. For example, when a secondary data source has an attribute value that is the same as a primary data source, and the value is determined to be incorrect when compared to an actual data source, then the probability that the secondary data source copied from the primary data source is elevated. In some implementations, the determination of the probability may be output for human examination. For example, a prediction with a certain probability threshold that a secondary data source is copying from another data source may be flagged for further examination. A human operator may determine if the secondary data source has in fact copied from one or more other data sources (e.g., other primary data sources or other secondary data sources), and the determination results from the human operators may be stored to provide positive and negative examples on which future calculations may be based. Information about a value's correctness may be manually collected or estimated, and then utilized in the Bayesian model.

The determination of whether a data source copied an entity listing from other data sources may be applied to a variety of applications. For example, local listings data in a mapping application may draw data from multiple sources including commercial information feeds, web crawls, and user edits. The utilization of multiple sources introduces redundancy (e.g., websites that are crawled may have obtained data from a commercial feed or from other websites). By identifying and removing from consideration data sources that are redundant, the number of data sources that the mapping application draws information from may be reduced, thereby saving on storage and computational power.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

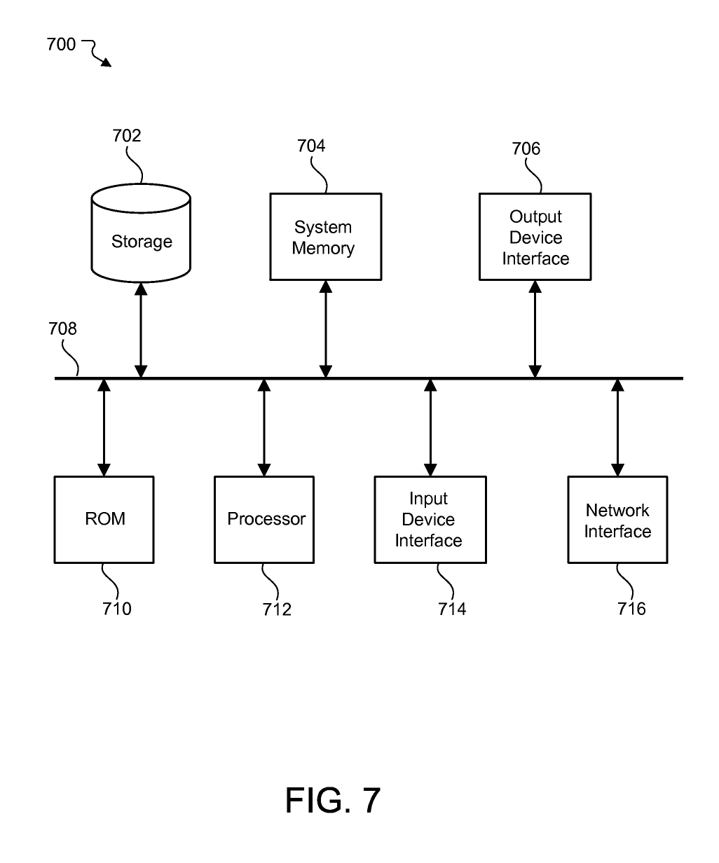

FIG. 7 conceptually illustrates an example electronic system with which some implementations of the subject technology are implemented. Electronic system 700 can be a computer, phone, PDA, or any other sort of electronic device. Such an electronic system includes various types of computer readable media and interfaces for various other types of computer readable media. Electronic system 700 includes a bus 708, processing unit(s) 712, a system memory 704, a read-only memory (ROM) 710, a permanent storage device 702, an input device interface 714, an output device interface 706, and a network interface 716.

Bus 708 collectively represents all system, peripheral, and chipset buses that communicatively connect the numerous internal devices of electronic system 700. For instance, bus 708 communicatively connects processing unit(s) 712 with ROM 710, system memory 704, and permanent storage device 702.

From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. Some implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such as random access memory. System memory 704 stores some of the instructions and data that the processor needs at runtime. In some implementations, the processes of the subject disclosure are stored in system memory 704, permanent storage device 702, and/or ROM 710. For example, the various memory units include instructions for deleting duplications in data feeds in accordance with some implementations. From these various memory units, processing unit(s) 712 retrieves instructions to execute and data to process in order to execute the processes of some implementations.

Bus 708 also connects to input and output device interfaces 714 and 706. Input device interface 714 enables the user to communicate information and select commands to the electronic system. Input devices used with input device interface 714 include, for example, alphanumeric keyboards and pointing devices (also called “cursor control devices”). Output device interface 706 enables, for example, the display of images generated by the electronic system 700. Output devices used with output device interface 706 include, for example, printers and display devices, such as cathode ray tubes (CRT) or liquid crystal displays (LCD). Some implementations include devices such as a touchscreen that functions as both input and output devices.

Finally, as shown in FIG. 7, bus 708 also couples electronic system 700 to a network (not shown) through a network interface 716. In this manner, the computer can be a part of a network of computers, such as a local area network (“LAN”), a wide area network (“WAN”), or an Intranet, or a network of networks, such as the Internet. Any or all components of electronic system 700 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

What is claimed is:

1. A computer-implemented method of filtering data sources, the method comprising:
receiving data corresponding to an entity listing from a set of data sources comprising one or more primary data sources and a secondary data source;
grouping the received data based on at least one attribute of the entity listing;
identifying, for each of a plurality of attributes of the entity listing, common values between data from the one or more primary data sources and data from the secondary data source;
calculating a probability that the secondary data source copied data from the one or more primary data sources based on the identified common values;
determining that the calculated probability is greater than a predetermined value; and
removing the secondary data source from a list of secondary data sources.

2. The computer-implemented method of claim 1, wherein the calculating the probability that the secondary data source copied data from the one or more primary data sources comprises using a Bayesian statistical model.

3. The computer-implemented method of claim 2, wherein the Bayesian statistical model is based on a probability that an attribute value from the secondary data source matches attribute values from the one or more primary data sources if the secondary data source copied the attribute value from the one or more primary data sources.

4. The computer-implemented method of claim 3, wherein the Bayesian statistical model is further based on a probability that an attribute value from the secondary data source matches attribute values from the one or more primary data sources if they secondary data source did not copy the attribute value from the one or more primary data sources.

5. The computer-implemented method of claim 1, wherein the at least one attribute of the entity listing is selected from the group consisting of a business name, an address, location coordinates, a telephone number, a uniform resource locator (URL), and an email.

6. The computer-implemented method of claim 1, wherein identifying the common values between data from the one or more primary data sources and the secondary data source comprises comparing, for each of the plurality of attributes, a value obtained from the one or more primary data sources and a value obtained from the secondary data source, and determining that the values match.

7. The computer-implemented method of claim 1, wherein removing the secondary data source from the list of secondary data sources further comprises flagging the secondary data source for inspection by a human operator, and receiving input from the human operator to remove the secondary data source from the list of secondary data sources.

8. A machine-readable medium comprising instructions stored therein, which when executed by a system, cause the system to perform operations comprising:
receiving a first set of data for a listing from a primary data source, the first set of data comprising at least one attribute;
receiving a second set of data for the listing from a secondary data source, the second set of data comprising the at least one attribute;
identifying common values for the at least one attribute between the first set of data and the second set of data for the listing;
calculating a probability that the set of data from the secondary data source was copied from the set of data from the primary data source based on the identified common attributes; and
removing the secondary data source from a list of secondary data sources when the calculated probability is greater than a predetermined value.

9. The machine-readable medium of claim 8, wherein the calculating of the probability that the set of data from the secondary data source was copied from the set of data from the primary data source comprises using a Bayesian statistical model.

10. The machine-readable medium of claim 9, wherein the Bayesian statistical model is based on a probability that an attribute value from the secondary data source matches attribute values from the one or more primary data sources if the secondary data source copied the attribute value from the one or more primary data sources.

11. The machine-readable medium of claim 10, wherein the Bayesian statistical model is further based on a probability that an attribute value from the secondary data source matches attribute values from the one or more primary data sources if they secondary data source did not copy the attribute value from the one or more primary data sources.

12. The machine-readable medium of claim 8, wherein the at least one attribute of the first set of data and the second set of data is selected from the group consisting of a business name, an address, location coordinates, a telephone number, a uniform resource locator (URL), and an email.

13. The machine-readable medium of claim 8, wherein identifying the common attributes between data from the primary data source and the secondary data source comprises comparing, for each attribute of the at least one attribute, a value obtained from the primary data source and a value obtained from the secondary data source, and determining that the values match.

14. The machine-readable medium of claim 8, wherein removing the secondary data source from the list of secondary data sources further comprises flagging the secondary data source for inspection by a human operator, and receiving input from the human operator to remove the secondary data source from the list of secondary data sources.

15. A system for determining filtering data sources in a web-based mapping application, the system comprising:
one or more processors; and
a machine-readable medium comprising instructions stored therein, which when executed by the processors, cause the processors to perform operations comprising:
receiving data corresponding to an entity listing of the mapping application from a set of data sources comprising one or more primary data sources and a secondary data source;
grouping the received data based on at least one attribute of the entity listing;
identifying, for each of a plurality of attributes of the entity listing, common values between data from the one or more primary data sources and data from the secondary data source;
calculating a probability that the secondary data source copied data from the one or more primary data sources based on the identified common values;
determining that the calculated probability is greater than a predetermined value; and
removing the secondary data source from a list of secondary data sources.

16. The system of claim 15, wherein the at least one attribute of the entity listing is selected from the group consisting of a business name, an address, location coordinates, a telephone number, a uniform resource locator (URL), and an email.

17. The system of claim 16, wherein the calculating the probability that the secondary data source copied data from the one or more primary data sources comprises using a Bayesian statistical model.

18. The system of claim 17, wherein the Bayesian statistical model is based on a probability that an attribute value from the secondary data source matches attribute values from the one or more primary data sources if the secondary data source copied the attribute value from the one or more primary data sources.

19. The system of claim 18, wherein the Bayesian statistical model is further based on a probability that an attribute value from the secondary data source matches attribute values from the one or more primary data sources if they secondary data source did not copy the attribute value from the one or more primary data sources.

20. The system of claim 15, wherein removing the secondary data source from the list of secondary data sources further comprises flagging the secondary data source for inspection by a human operator, and receiving input from the human operator to remove the secondary data source from the list of secondary data sources.
